(19) United States
(12) Patent Application Publication
(10) Pub. No.: US 2006/0246876 A1
(43) Pub. Date: Nov. 2, 2006

(54) System for notifying a cellular telephone user that a call involves another telephone located outside of a defined service charge range of user's network

(76) Inventors: Faisal M. Awada, Round Rock, TX (US); Joe Nathan Brown, Austin, TX (US); Philip Bernard Burkes, Round Rock, TX (US); Victor Espinoza JR., Pflugerville, TX (US)

Correspondence Address: IBM CORPORATION;INTELLECTUAL PROPERTY LAW, 11400 BURNET ROAD, AUSTIN, TX, 78758, US

(21) Appl. No.: 11/117,145

(22) Filed: Apr. 28, 2005

(51) Int. Cl. H04Q 7/22

(52) U.S. Cl. 455/412.2; 455/422.1

(57) ABSTRACT

A cellular telephone network system for notifying a cellular telephone user that a telephone call connected to the user's cellular telephone involves another telephone outside of the defined service charge range of the user's network comprising the combination of assigning to each telephone call to and from the another telephone an identifier for the network of the another telephone, an implementation in the user's cellular telephone for reading the another telephone network identifier and an implementation in the user's cellular telephone, responsive to means for reading the identifier, for displaying a message when the another telephone is in a network outside of the defined service charge range of the user's network. The user is enabled to block such calls from outside the defined charge range whereby additional charges are avoided.

### TECHNICAL FIELD

The present invention relates to telecommunications systems and particularly to mobile wireless cellular telephone networks.

### BACKGROUND OF RELATED ART

With the globalization of business, industry and trade wherein transactions and activities within these fields have been changing from localized organizations to diverse transactions over the face of the world, the telecommunications industries have, accordingly, been expanding rapidly. Wireless cellular telephone networks have been leading the way in this expansion. Their technological advance has propelled the mobile methods of doing business. The wireless cellular industry now has hundreds of millions of interconnected mobile telephones. This advance of technology has been so rapid, and has arisen from so many discrete starting points in the United States and world wide, that the industry has continuously faced problems with the tracking and, particularly, the distribution of the charges and fees among the several interconnected networks that may have participated in the routing of the wireless cellular calls.

The resulting cumulative charges to cellular telephone customers has been a major problem to both cellular telephone service providers and to customers. With expanded services, great numbers of both business and personal cellular telephone users are often faced with sky-rocketing unanticipated costs. This provokes anger at the providers who must provide extra staff to explain convoluted charges to the inquiring billed customers.

As a result cellular telephone service providers are continually trying to work with their customers to provide optimum categories of network telephone cellular telephone services suitable to their respective customers and to bill a flat fee for a particular defined network range within which, all calls, both incoming and outgoing are covered. The effectiveness of such a flat fee network range of calls to the cellular telephone of the customer is often subverted because the receiving telephone has no way of recognizing whether a particular cellular telephone is within the range of the one fee service charge network.

### SUMMARY OF THE PRESENT INVENTION

The present invention offers one solution to the problem discussed above of unexpected and excessive usage fees due to the inability of the wireless cellular telephone users to accurately and immediately determine whether a cellular telephone is within the service provider defined location range for the user.

Accordingly, the present invention provides a cellular telephone network system for notifying a cellular telephone user that a telephone call connected to the user's cellular telephone involves another telephone outside of the defined service charge range of the user's network comprising the combination of means for assigning to each telephone call to and from the another telephone an identifier for the network of the another telephone, means in the user's cellular telephone for reading the another telephone network identifier and means in the user's cellular telephone, responsive to means for reading the identifier, for displaying a message when the another telephone is in a network outside of the defined service charge range of the user's network. While the invention is applicable to received calls, it may also be used for calls made from the user's cellular telephone. Also, the other telephone outside of the network may be either a cellular or non-cellular telephone. The users receiving cellular telephone calls may have the means enabling the user to block telephone calls received from a telephone outside of said defined service range of the user's network to thereby avoid any extra charges. Also, the receiving cellular telephone may include means enabling the receiver user to display the received telephone call source before blocking the telephone call.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a set of interconnected cellular networks each including portions of a Public Switched Transmission Networks (PSTNs) showing channel paths to and from both conventional land-wired and mobile wireless cellular channels on which the present invention is implemented;

FIG. 2 is a generalized block view of a conventional wireless cellular telephone member that may be used as the receiving telephone in the present invention;

FIG. 3 is a flowchart describing how the wireless cellular telephone system of the present invention is set up to handle received telephone calls to determine whether the call is from a network outside of the network range where a predetermined use charge is in effect; and

FIG. 4 is a flowchart of a method of doing business according to the set up of FIG. 3 wherein the receiving user is enabled to identify whether a received cellular telephone call is from a telephone within the network wherein no additional fee is charged and to block telephone calls from telephones within networks wherein additional fees are applicable.

### DETAILED DESCRIPTION OF THE PREFERRED EMBODIMENT

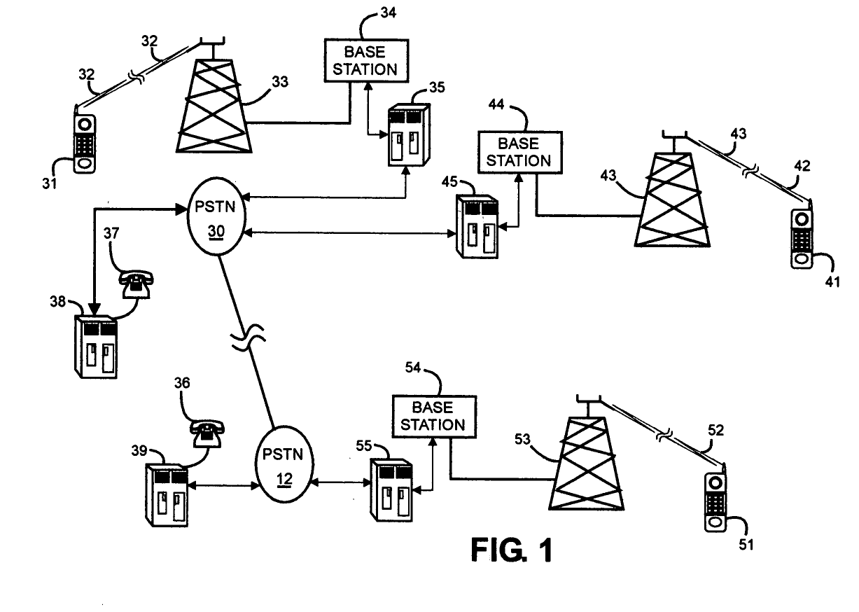

Referring to FIG. 1, a cellular telecommunications network system is diagrammatically shown, set up so that cellular telephones may receive cellular calls from interconnected telephone network systems using PSTNs showing channel paths to and from both conventional wired and mobile cellular wireless channels and devices. Conventional telephones, e.g. phones 37, are connected to the PSTN 30 via local switching centers or switching nodes 38 in a fully wired telecommunications system. Conventionally, these switching nodes have many telephones connected to them. The centers operate to control the channel connections, i.e. switch into and out of the PSTN 30 those calls originated or terminated at telephone stations 37. In a similar way, mobile cellular telephones 31 and 41 are connected into the PSTN 30. There are cellular telephone communication paths 32 and 42 from the respective cellular phone antenna to antennae on towers 33 and 43. The distribution or routing of the cellular telephone call to, from and within the PSTN 30 is quite similar to the routing of conventional wired telephone calls. Similarly, in the long range RF communication via cellular towers 33 or 43, the signals are passed through base stations 34 or 44 to switching center 35 or 45, which then controls the routing of the calls to PSTN 30. The conventional wired phones 37 are also connected to their switching centers 38.

At this point, it would be appropriate to consider some background with respect to wired and wireless cellular telephones. The standard wired telecommunications system, which has been in use world wide for well over 100 years, is the conventional hand held or speaker input wired into a base, which, in turn, is wired into a PSTN with wired switched channel paths to and from other telephones or like devices through their bases. These telephones are respectively connected to the PSTN via local switching centers or switching nodes in a fully wired telecommunication system. Conventionally, these switching centers have many telephones connected to each. The centers operate to control the channel connections, i.e. switch into and out of the PSTN, those calls originated or terminated at telephone stations.

In addition, there has been developed over the past 20 years, the mobile wireless long range RF “wireless” telephone system, which has been commercialized primarily as the “cellular” telephone system. Before the cellular wireless phone system was developed, long range mobile wireless phones were relatively rudimentary; they were usually in automobiles. There was usually one central tower with about 25 channels available on the tower. The mobile wireless telephone needed a large powerful transmitter, usually in the automobile, which had to transmit up to 50 miles (too cumbersome for any personal or portable phone).

In the cellular system for the hand held mobile wireless phone, an area such as a city is broken up into small area cells. Each cell is about 10 square miles in area. Each has its base station that has a tower for receiving/transmitting and a base connected into PSTN. Even though a typical carrier is allotted about 800 frequency channels, the creation of the cells permits extensive frequency reuse so that tens of thousands of people in the city can be using their cell phones simultaneously. Cell phone systems are now preferably digital with each cell having over 160 available channels for assignment to users. In a large city, there may be hundreds of cells, each with its tower and base station. Because of the number of towers and users per carrier, each carrier has a Mobile Telephone Switching Office (MTSO) that controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two-way long range RF communication. In the United States, cell phones are assigned frequencies in the 824-894 MHz ranges. Since transmissions between the cell telephone and cell tower are digital but the speaker and microphone in the telephone are analog, the cell telephone has to have a D to A converter from the input to the phone speaker, and an A to D converter from the microphone to the output to the cell tower.

Returning now to FIG. 1, for purposes of describing the present invention, assume that there is another network remote from the above described basic network within which receiving cellular telephones 31 and 41 receive calls. The service provider has a set up wherein all calls made in the network using PSTN 30 are within the no extra charge network. However, calls coming from the remote network using PSTN 12 are subject to an extra charge when received by receiving telephone 31, for example. The network PSTN 12 is shown to include conventional telephones, e.g. phones 36 are connected to the PSTN 12 via local switching centers or switching nodes 39 in a fully wired telecommunications system. In a similar way, mobile cellular telephones 51 is connected into the PSTN 12. There are cellular telephone communication paths 52 from the cellular phone 51 antenna to the antenna on tower 53. The distribution or routing of the cellular telephone call to, from and within the PSTN 12 is quite similar to the routing of conventional wired telephone calls. Similarly, in the long range RF communication via cellular towers 53, the signals are passed through base stations 54 to switching center 55, which then controls the routing of the calls to PSTN 12. The conventional wired phones 37 are also connected to their switching centers 39.

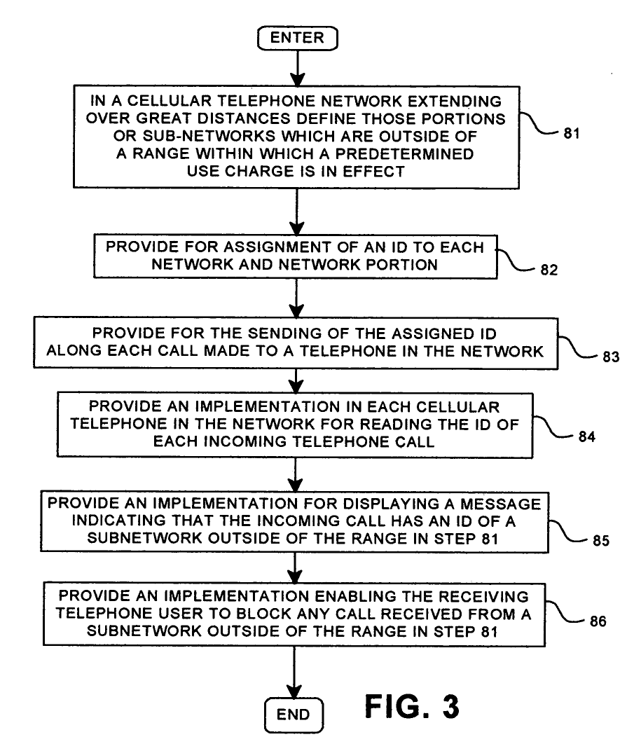

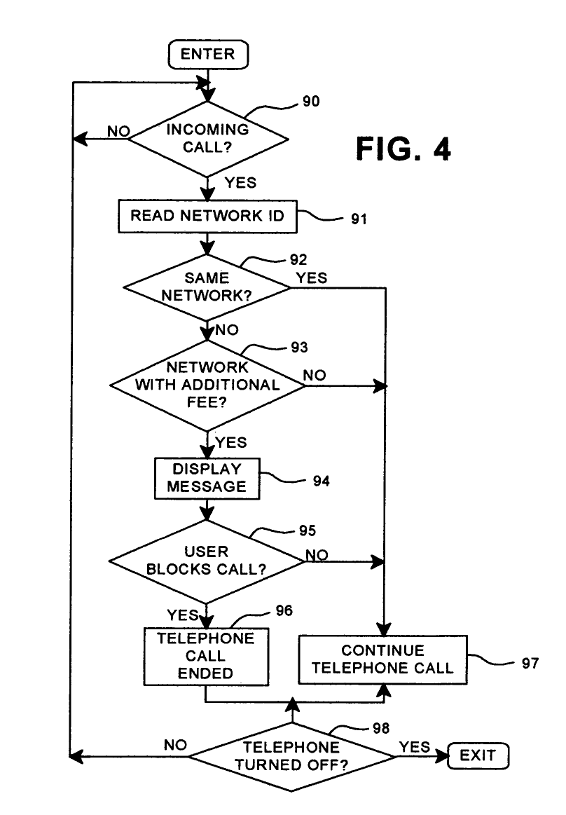

Thus, in the descriptions that follow with respect to FIGS. 3 and 4, calls from either wired telephone 36 or cellular telephone 51 to either receiving telephone 31 or 41 will be considered to be calls from telephones outside of the service range of the receiving phones user's network.

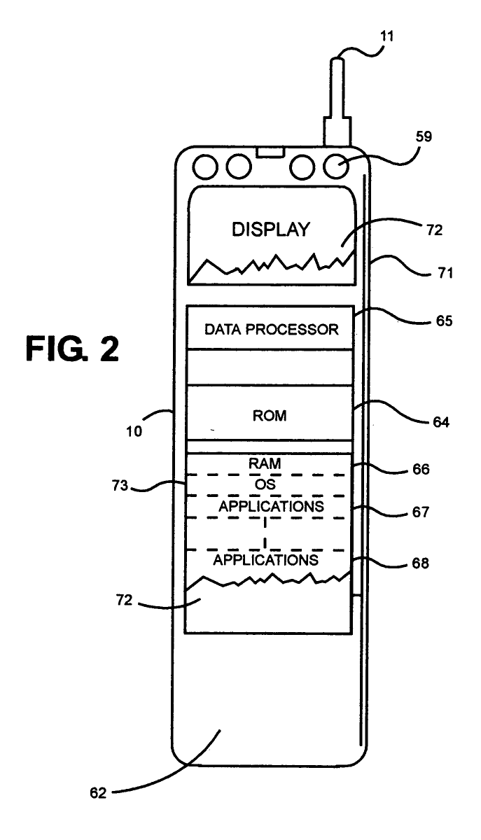

Now with respect to FIG. 2, an illustrative cellular telephone member structure that may be used in the practice of the present invention will be described. The generalized cell telephone shown in FIG. 2 includes a data processor, operating system, about 2 to 4 MB of Random Access Memory (RAM) and a permanent programmable memory, a programmable Read Only Memory (ROM) that may be an EPROM or flash ROM. Because these flash ROMs can now provide 4 MB of capacity, all of the application programs and routines, including those used in the present invention, are conventionally stored on the telephone's RAM and may also be stored in this ROM. In addition, the telephone operating system and built-in applications are also conventionally stored in the ROM. Thus, the cellular telephone 10 includes a data processor 65, a programmable ROM 64, a RAM 66 that is shown in an operational state loaded with the telephone's operating system 73 and its application programs 67, including routines required to practice the present invention. The telephone 10 also includes antenna 11, control buttons 59 and display screen 72, all included in housing 62.

Now, with respect to FIG. 3, there will be generally described a system for handling incoming calls to a receiving cellular telephone, which call may be outside of the network range within which a predetermined fixed use charge is in effect. In a cellular telephone network system, there is provided for each receiving telephone within the network, a routine defining which other networks or sub-networks are outside of a location range within which a predefined use charge is in effect, step 81. Provision is made for assigning to each network and/or each discrete network portion, a specific ID, step 82. Provision is also made for the sending of this assigned ID along with the call being made throughout the network, step 83. An implementation is provided in each cellular telephone for reading the ID of each incoming telephone call, step 84. In each receiving cellular telephone an implementation is provided, step 85, for displaying a message that an incoming call has an ID indicating that the call comes from a telephone in a network or network portion outside of the range defined in step 81. A further implementation is provided, step 86, enabling the receiving cellular telephone user to block any call received from a telephone in a network or sub-network outside of the range defined in step 81.

Now, with respect to FIG. 4, there will generally be described an illustration of how a specific incoming telephone call received on a cellular telephone may be handled using the protocols set up in FIG. 3. An incoming call is awaited on the cellular telephone, step 90. When Yes it arrives, its network ID is read, step 91, and a determination is made, step 92, as to whether the call is from a telephone within the same network. If No, a further determination is made as to whether the ID indicates that the sending telephone is in a network that would result in an additional fee, step 93. If Yes, then step 94, there is displayed on the receiving cellular phone display a message indication that the call is from an additional charge network. At this point, any other information about the incoming call may also be displayed so that the user has an opportunity to decide whether he still wishes to accept the call. If the determination is Yes, the user wishes to block the call, then step 96, the call is dropped. However, in the following decisions: block 92 is Yes, block 93 is No or block 95 is No, then the telephone call is accepted and continued, step 97. After, either step 96 or 97, a determination may be conveniently made as to whether the cellular phone is to be turned off, step 98. If Yes, the cellular telephone is exited. If No, then the process is returned to step 90.

Although certain preferred embodiments have been shown and described, it will be understood that many changes and modifications may be made therein without departing from the scope and intent of the appended claims.

What is claimed is:

1. A cellular telephone network system for notifying a cellular telephone user that a telephone call connected to the user's cellular telephone involves another telephone outside of the defined service charge range of the user's network comprising:
means for assigning to each telephone call to and from said another telephone an identifier for the network of said another telephone;
means in said user's cellular telephone for reading said another telephone network identifier; and
means in said user's cellular telephone, responsive to means for reading said identifier, for displaying a message when said another telephone is in a network outside of the defined service charge range of the user's network.

2. The cellular telephone network system of claim 1 wherein said telephone call is received from said another telephone.

3. The cellular telephone network system of claim 2 wherein said user is charged an extra fee for telephone calls received from a telephone outside of said defined service range of the user's network.

4. The cellular telephone network system of claim 3 further including means in said receiving user's cellular telephone enabling the user to block telephone calls received from a telephone outside of said defined service range of the user's network.

5. The cellular telephone network system of claim 3 wherein said user is not charged an extra fee for telephone calls received from a telephone within said defined service range of the user's network.

6. The cellular telephone network system of claim 3 wherein said another telephone is a non-cellular telephone.

7. In a cellular telephone network a method for notifying a cellular telephone user that a telephone call connected to the user's cellular telephone involves another telephone outside of the defined service charge range of the user's network comprising:
assigning to each telephone call to and from said another telephone an identifier for the network of said another telephone;
reading in said user's cellular telephone, said another telephone network identifier; and
displaying a message on said user's cellular telephone, responsive to reading said identifier, when said another telephone is in a network outside of the defined service charge range of the user's network.

8. The cellular telephone network method of claim 7 wherein said telephone call is received from said another telephone.

9. The cellular telephone network method of claim 8 wherein said user is charged an extra fee for telephone calls received from a telephone outside of said defined service range of the user's network.

10. The cellular telephone network method of claim 9 further including the step of enabling the user to block, in said receiving user's cellular telephone, telephone calls received from a telephone outside of said defined service range of the user's network.

11. The cellular telephone network method of claim 10 further including the step of enabling the receiver user to display the received telephone call source before blocking the telephone call.

12. The cellular telephone network method of claim 10 wherein said user is not charged an extra fee for telephone calls received from a telephone within said defined service range of the user's network.

13. The cellular telephone network method of claim 9 wherein said another telephone is a non-cellular telephone.

14. A computer program having code recorded on a computer readable medium for notifying a cellular telephone user that a telephone call connected to the user's cellular telephone involves another telephone outside of the defined service charge range of the user's cellular telephone network comprising:
means for assigning to each telephone call to and from said another telephone an identifier for the network of said another telephone;
means in said user's cellular telephone for reading said another telephone network identifier; and
means in said user's cellular telephone, responsive to means for reading said identifier, for displaying a message when said another telephone is in a network outside of the defined service charge range of the user's network.

15. The computer program of claim 14 wherein said telephone call is received from said another telephone.

16. The computer program of claim 15 wherein said user is charged an extra fee for telephone calls received from a telephone outside of said defined service range of the user's network.

17. The computer program of claim 16 further including means in said receiving user's cellular telephone enabling the user to block telephone calls received from a telephone outside of said defined service range of the user's network.

18. The computer program of claim 17 wherein said user is not charged an extra fee for telephone calls received from a telephone within said defined service range of the user's network.

19. The computer program of claim 16 wherein said another telephone is a non-cellular telephone.

20. The computer program of claim 16 wherein said another telephone is a cellular telephone.
